(19) United States
(12) Patent Application Publication
(10) Pub. No.: US 2026/0229635 A1
(43) Pub. Date: Aug. 6, 2026

(54) OUTER CASING AND BATTERY

(71) Applicant: TOYOTA JIDOSHA KABUSHIKI KAISHA, Toyota-shi (JP)

(72) Inventor: Daisuke SIKANAI, Tokai-shi (JP)

(73) Assignee: TOYOTA JIDOSHA KABUSHIKI KAISHA, Toyota-shi (JP)

(21) Appl. No.: 19/416,430

(22) Filed: Dec. 11, 2025

(30) Foreign Application Priority Data
Feb. 6, 2025 (JP) 2025-018776

(51) Int. Cl. H01M 10/6551; H01M 10/613; H01M 10/625; H01M 10/647; H01M 50/103; H01M 50/15; H01M 50/46; B60R 16/033

(52) U.S. Cl. CPC H01M 10/6551; H01M 10/613; H01M 10/625; H01M 10/647; H01M 50/103; H01M 50/15; H01M 50/46; B60R 16/033; H01M 2220/20

(57) ABSTRACT

An outer casing of a battery is configured to house an electrode assembly, and includes a plurality of recesses provided on at least one surface at intervals along one direction. With the recesses on the surface of the outer casing, the surface area of the outer casing is increased, and heat dissipation performance can be improved.

### CROSS-REFERENCE TO RELATED APPLICATION

This application claims priority to Japanese Patent Application No. 2025-018776 filed on February 6, 2025. The disclosure of the above-identified application, including the specification, drawings, and claims, is incorporated by reference herein in its entirety.

### BACKGROUND

### Technical Field

The present disclosure relates to an outer casing and a battery.

### Description of Related Art

Japanese Unexamined Patent Application Publication No. 2020-119832 (JP 2020-119832 A) discloses a power storage module including a battery case that houses a plurality of battery cells stacked in one direction. In the power storage module of JP 2020-119832 A, cooling fins protrude outward from the outer surface of the battery case to ensure heat dissipation performance.

### SUMMARY

Since the cooling fins protrude in the power storage module (battery) described in JP 2020-119832 A, the cooling fins may be damaged by external impact. Since the structure does not improve the heat dissipation properties of the battery cells themselves, there is room for improvement in terms of the heat dissipation performance.

In view of the above fact, an object of the present disclosure is to provide an outer casing and a battery that can improve impact resistance and heat dissipation performance.

An outer casing according to claim 1 is configured to house an electrode assembly and includes a plurality of recesses provided on at least one surface at intervals along one direction.

The outer casing according to claim 1 is configured to house the electrode assembly. The recesses are provided on at least one surface of the outer casing. A plurality of recesses is formed at intervals along one direction. Thus, the surface area of the outer casing is increased by the recesses, and the heat dissipation performance can be improved. That is, the recesses can function as cooling fins. Compared to a structure in which fins protrude outward from the outer casing, damage to the outer casing can be suppressed when a load is input from the outside.

In claim 1, the outer casing according to claim 2 further includes a can body and a cover. The cover is thicker than the can body. The recesses are provided in the cover.

In the outer casing according to claim 2, the can body is closed by the cover, and the cover is thicker than the can body. Since the recesses are formed in the relatively thick cover, high heat dissipation performance can be maintained even when the thickness of the cover is increased.

A battery according to claim 3 includes: the outer casing according to claim 1 or 2; and an electrode assembly housed in the outer casing. The electrode assembly is an electrode stack that is a stack of a plurality of unit electrode assemblies. The recesses extend in a stacking direction of the unit electrode assemblies.

In the battery according to claim 3, the recesses extend in the stacking direction of the unit electrode assemblies. Therefore, even when the battery expands in the stacking direction, the breakage of the outer casing can be suppressed.

In claim 3, the battery according to claim 4 further includes a thermal conductor provided inside the outer casing at a position where the thermal conductor faces the surface provided with the recesses.

In the battery according to claim 4, heat is effectively transferred from the thermal conductor to the surface of the outer casing provided with the recesses. Therefore, heat dissipation can further be promoted.

In claim 3, the battery according to claim 5 further includes a cooler provided outside the outer casing at a position where the cooler faces the surface provided with the recesses.

In the battery according to claim 5, the cooler is disposed to face the surface provided with the recesses. Therefore, the cooling performance can be improved.

As described above, the outer casing and the battery according to the present disclosure can improve the impact resistance and the heat dissipation performance.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic perspective view showing part of a battery according to an embodiment;

FIG. 2 is an enlarged plan view of a main part of the battery according to the embodiment; and

FIG. 3 is an enlarged sectional view of the main part taken along line 3-3 in FIG. 2.

### DETAILED DESCRIPTION OF EMBODIMENTS

A battery according to an embodiment will be described with reference to the drawings.

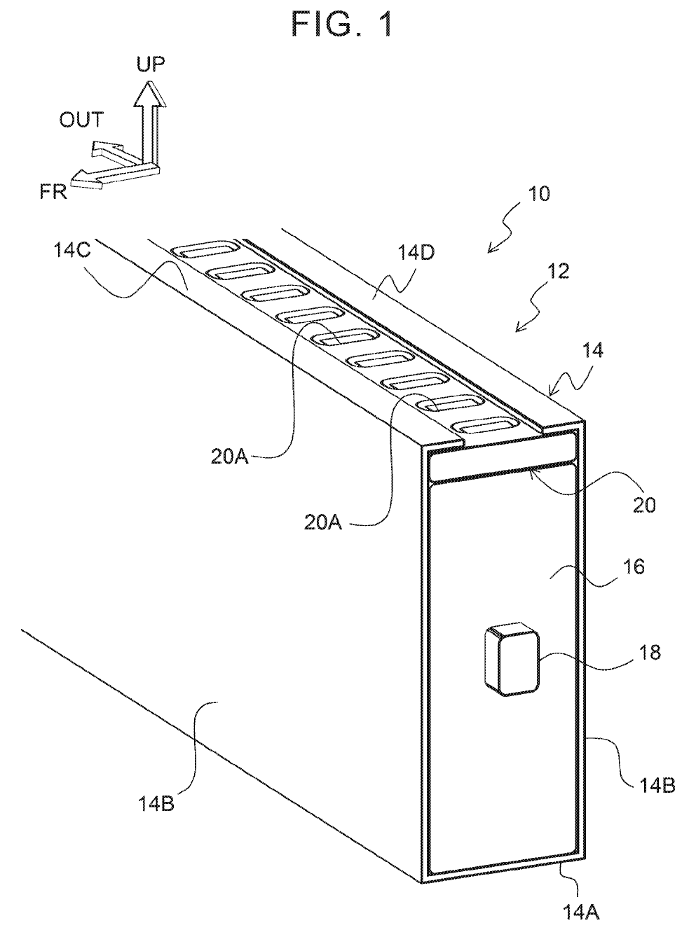

FIG. 1 is a schematic perspective view showing part of a battery (also referred to as "battery cell") 10 according to the embodiment. The battery 10 of the present embodiment constitutes, for example, a battery to be mounted on a vehicle. For convenience of the following description, the side indicated by arrow UP will be referred to as "upper side" in an up-down direction of the battery 10. The side indicated by arrow FR will be referred to as "front side" in a front-rear direction of the battery 10. The side indicated by arrow OUT will be referred to as "outer side" in a width direction of the battery 10. The directions indicated by arrows UP, FR, OUT need not coincide with the up-down direction, the front-rear direction, and the width direction of the vehicle including the battery 10.

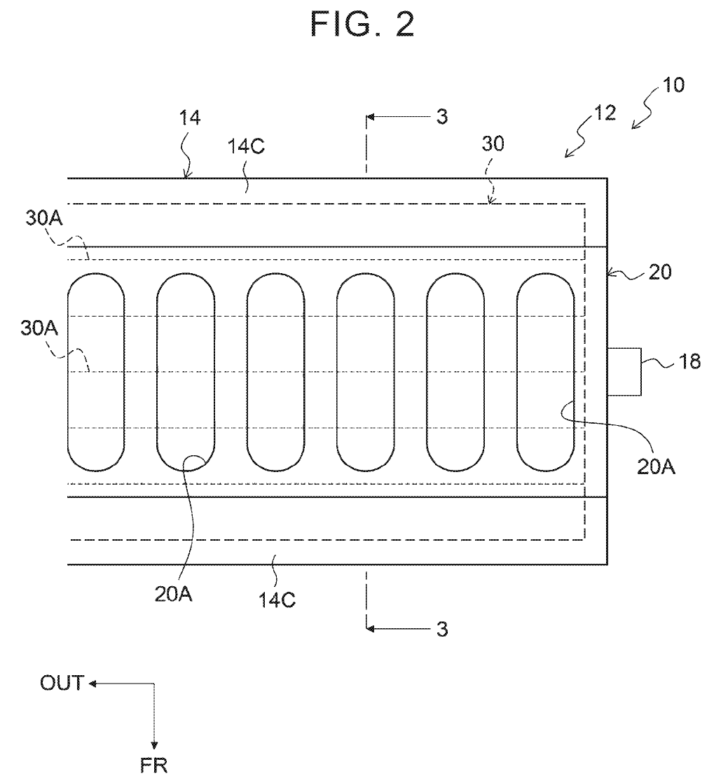

As shown in FIG. 1, the battery 10 includes an outer casing 12. The outer casing 12 includes a can body 14, terminal covers 16, and a top cover 20 serving as a cover. As shown in FIG. 2, an electrode assembly 30 is housed inside the outer casing 12.

As shown in FIG. 1, the can body 14 is formed by bending a plate-shaped metal member and includes a lower wall 14A located at the lower end of the battery 10 and extending in the front-rear direction and the width direction. Front-rear walls 14B extend upward from the front and rear ends of the lower wall 14A.

The front-rear wall 14B on the front side extends in the up-down direction and the width direction, and covers the front side of the electrode assembly 30 (see FIG. 2) housed inside the battery 10. The front-rear wall 14B on the rear side extends in the up-down direction and the width direction, and covers the rear side of the electrode assembly 30.

A front flange 14C extends rearward from the upper end of the front-rear wall 14B on the front side and covers the front end of the top cover 20 from above. A rear flange 14D extends forward from the upper end of the front-rear wall 14B on the rear side and covers the rear end of the top cover 20 from above.

The terminal covers 16 are disposed on both sides of the battery 10 in the width direction and are provided with terminals 18 electrically connected to the electrode assembly 30. The terminal cover 16 may be provided on only one side of the battery 10 in the width direction. In this manner, the can body 14 and the terminal covers 16 form a box-shaped housing.

The can body 14 has an opening at the top, and this opening is closed by the top cover 20. The top cover 20 is, for example, a plate-shaped member extending in the width direction with its thickness direction corresponding to the up-down direction and is thicker than the can body 14. The upper surface of the top cover 20 has recesses 20A.

FIG. 2 is an enlarged plan view of a main part of the battery according to the embodiment. As shown in FIG. 2, a plurality of recesses 20A is formed on the upper surface of the top cover 20 at intervals along the width direction (one direction).

The electrode assembly 30 housed inside the outer casing 12 of the present embodiment is a stack of a plurality of unit electrode assemblies 30A. The electrode assembly 30 of the present embodiment is, for example, an electrode assembly of an all-solid-state battery. The unit electrode assembly 30A is a laminate of an anode current collector, an anode active material layer, a solid electrolyte layer, a cathode active material layer, a cathode current collector, a cathode active material layer, a solid electrolyte layer, an anode active material layer, and an anode current collector. The unit electrode assembly 30A may be a known unit electrode assembly such as a unit electrode assembly for a lithium-ion battery or a unit electrode assembly for a sodium ion battery.

The unit electrode assemblies 30A are stacked in the front-rear direction. The recess 20A formed in the top cover 20 extends in the front-rear direction that is the stacking direction of the unit electrode assemblies 30A. Specifically, the recess 20A has a shape that recedes downward relative to the upper surface of the top cover 20, and has a substantially oval shape with its longitudinal direction corresponding to the front-rear direction in a plan view.

In the present embodiment, for example, the recesses 20A are formed at predetermined intervals in the width direction, and the distance between adjacent recesses 20A is smaller than the width of each recess 20A. Therefore, the portion of the top cover 20 between the adjacent recesses 20A protrudes upward from the bottoms of the recesses 20A to function as a cooling fin.

The length of the recess 20A in the front-rear direction is substantially constant and is about half the length of the battery 10 in the front-rear direction. The recess 20A formed at the farthest end in the width direction is offset inward in the width direction from the end of the top cover 20. Therefore, the end of the top cover 20 in the width direction and the end face of the battery 10 in the width direction are continuously connected.

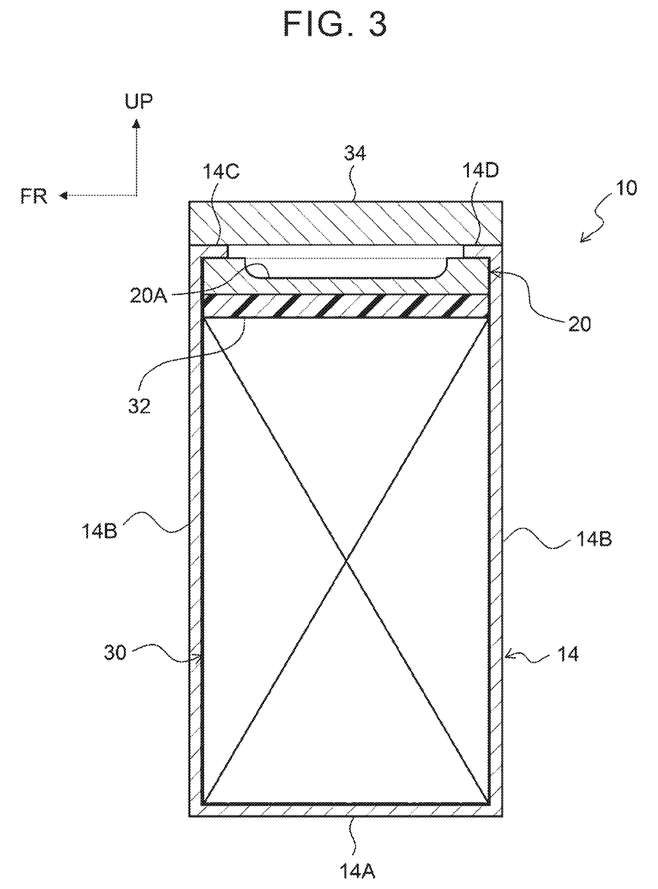

FIG. 3 is an enlarged sectional view of the main part taken along line 3-3 in FIG. 2. As shown in FIG. 3, the recess 20A has a depth of about half the thickness of the top cover 20. In the present embodiment, the recess 20A has, for example, a depth larger than the thickness of the can body 14. From the viewpoint of effective heat dissipation, the depth of the recess 20A is preferably 30% or more of the thickness of the can body 14. From the viewpoint of increasing the surface area of the top cover 20 and maintaining the strength of the top cover 20, the depth of the recess 20A is preferably set to 30% or more and 70% or less of the thickness of the top cover 20.

A thermal conductor 32 is disposed below the top cover 20. The thermal conductor 32 is disposed inside the outer casing 12, and is, for example, a resin sheet having high thermal conductivity. However, the present disclosure is not limited to this, and the thermal conductor may be made of a material other than resin. In the present embodiment, for example, the thermal conductor 32 is in contact with both the top cover 20 and the electrode assembly 30, but the present disclosure is not limited to this.

A cooler 34 is provided outside the outer casing 12 at a position where the cooler 34 faces the top cover 20. The cooler 34 is a substantially flat plate-shaped member made of a metal having high thermal conductivity and may have a coolant channel inside.

### Functions

Next, functions of the battery 10 according to the present embodiment will be described.

As shown in FIGS. 1 to 3, the battery 10 according to the present embodiment includes the can body 14 (outer casing 12) that can house the electrode assembly 30. The recesses 20A are provided on at least one surface of the can body 14. A plurality of recesses 20A is formed at intervals along one direction. Thus, the surface area of the can body 14 is increased by the recesses 20A, and the heat dissipation performance can be improved. That is, the recesses 20A can function as cooling fins.

Compared to a structure in which fins protrude outward from the can body 14, damage to the outer casing 12 can be suppressed when a load is input from the outside. Thus, the battery 10 of the present embodiment can improve the impact resistance and the heat dissipation performance.

In the present embodiment, the opening of the can body 14 is closed by the top cover 20, and the top cover 20 is thicker than the can body 14. Since the recesses 20A are formed in the relatively thick top cover 20, high heat dissipation performance can be maintained even when the thickness of the top cover 20 is increased.

In the present embodiment, the recesses 20A extend in the stacking direction of the unit electrode assemblies 30A. Therefore, even when the battery 10 expands in the stacking direction, the breakage of the outer casing 12 can be suppressed.

In the present embodiment, heat is effectively transferred from the thermal conductor 32 to the top cover 20 of the outer casing 12 having the recesses 20A. Therefore, heat dissipation can further be promoted. In particular, in the present embodiment, the cooler 34 is disposed to face the top cover 20 having the recesses 20A. Therefore, the cooling performance can be improved.

Although the battery 10 according to the embodiment has been described above, the present disclosure is not limited to this and can be embodied in various forms without departing from the spirit of the present disclosure. For example, in the above embodiment, the recesses 20A are formed only in the top cover 20, but the present disclosure is not limited to this. The recesses may be formed in the can body 14. In this case, the surface of the can body 14 is uneven, and the heat dissipation performance can be improved. Compared to the case where fins etc. protrude from the can body 14, the impact resistance can be improved.

In the above embodiment, as shown in FIG. 2, the recesses 20A are formed at a constant pitch and have substantially the same shape, but the present disclosure is not limited to this. For example, the pitch of the recesses may be changed depending on the required heat dissipation performance. The shape of the recess may also be changed.

In the above embodiment, the extending direction of the recess 20A coincides with the stacking direction of the unit electrode assemblies 30A, but the present disclosure is not limited to this. For example, part or all of the recesses may be set in a direction intersecting the stacking direction of the unit electrode assemblies.

In the above embodiment, the thermal conductor 32 and the cooler 34 are provided as shown in FIG. 3, but the present disclosure is not limited to this. The thermal conductor 32 and the cooler 34 may be omitted. The thermal conductor 32 and the cooler 34 may be disposed at positions where they do not face the top cover 20.

The following appendices are disclosed regarding the above embodiment.

### Appendix 1

An outer casing including:

a can body configured to house an electrode assembly; and

a plurality of recesses provided on at least one surface of the can body at intervals along one direction.

### Appendix 2

The outer casing according to Appendix 1, in which:

the can body has an opening that is closed by a cover;

the cover is thicker than the can body; and

the recesses are provided in the cover.

### Appendix 3

A battery including:

the outer casing according to Appendix 1 or 2; and

an electrode assembly housed in the outer casing, in which:

the electrode assembly is an electrode stack that is a stack of a plurality of unit electrode assemblies; and

the recesses extend in a stacking direction of the unit electrode assemblies.

### Appendix 4

The battery according to Appendix 3, further including a thermal conductor provided inside the outer casing at a position where the thermal conductor faces the surface provided with the recesses.

### Appendix 5

The battery according to Appendix 3 or 4, further including a cooler provided outside the outer casing at a position where the cooler faces the surface provided with the recesses.

What is claimed is:

1. An outer casing configured to house an electrode assembly, the outer casing comprising a plurality of recesses provided on at least one surface at intervals along one direction.

2. The outer casing according to claim 1, further comprising a can body and a cover, wherein:
the cover is thicker than the can body; and
the recesses are provided in the cover.

3. A battery comprising:
the outer casing according to claim 1; and
an electrode assembly housed in the outer casing, wherein:
the electrode assembly is an electrode stack that is a stack of a plurality of unit electrode assemblies; and
the recesses extend in a stacking direction of the unit electrode assemblies.

4. The battery according to claim 3, further comprising a thermal conductor provided inside the outer casing at a position where the thermal conductor faces the surface provided with the recesses.

5. The battery according to claim 3, further comprising a cooler provided outside the outer casing at a position where the cooler faces the surface provided with the recesses.
